(19) United States
(12) Patent Application Publication
(10) Pub. No.: US 2026/0331818 A1
(43) Pub. Date: Oct. 22, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Hajime MATSUI, Mie (JP); Akiko SUZUKI, Mie (JP)

(21) Appl. No.: 19/111,272

(22) PCT Filed: Aug. 31, 2023
(86) PCT No.: PCT/JP2023/031745

§ 371 Date: Mar. 12, 2025

(30) Foreign Application Priority Data
Sep. 21, 2022 (JP) 2022-149882

(51) Int. Cl. H01R 13/506; H01R 13/436

(52) U.S. Cl. CPC H01R 13/506; H01R 13/436

(57) ABSTRACT

A connector is for holding a first terminal and a second terminal and includes a housing including a first terminal accommodating portion having a first cavity for accommodating the first terminal and a second terminal accommodating portion having a second cavity for accommodating the second terminal, a first holding member for holding the first terminal in the first cavity by being united with the first terminal accommodating portion at a first proper position, and a second holding member for holding the second terminal in the second cavity by being united with the second terminal accommodating portion at a second proper position. The first holding member reaches the first proper position along a first direction to be united with the first terminal accommodating portion. The second holding member reaches the second proper position along a second direction different from the first direction to be united with the second terminal accommodating portion.

### TECHNICAL FIELD

The present disclosure relates to a connector.

### BACKGROUND

Patent Document 1 discloses a connector provided with a housing formed with a plurality of terminal accommodation chambers in upper and lower stages. Wire terminals accommodated in the terminal accommodation chambers in the upper and lower stages are retained by a common retainer.

### PRIOR ART DOCUMENT

### Patent Document

Patent Document 1: JP 2004-055470 A

### SUMMARY OF THE INVENTION

### Problems to be Solved

Here, it is desired to more suppress an assembly failure of a connector.

Accordingly, the present disclosure aims to suppress an assembly failure of a connector.

### Means to Solve the Problem

The present disclosure is directed to a connector for holding a first terminal and a second terminal, the connector being provided with a housing including a first terminal accommodating portion having a first cavity for accommodating the first terminal and a second terminal accommodating portion having a second cavity for accommodating the second terminal, a first holding member for holding the first terminal in the first cavity by being united with the first terminal accommodating portion at a first proper position, and a second holding member for holding the second terminal in the second cavity by being united with the second terminal accommodating portion at a second proper position, the first holding member reaching the first proper position along a first direction to be united with the first terminal accommodating portion, and the second holding member reaching the second proper position along a second direction different from the first direction to be united with the second terminal accommodating portion.

### Effect of the Invention

According to the present disclosure, an assembly failure of a connector is suppressed.

### BRIEF DESCRIPTION OF THE DRAWINGS

FIG. 1 is a perspective view showing a connector according to an embodiment.

FIG. 2 is an exploded perspective view showing the connector.

FIG. 3 is an exploded perspective view showing the connector.

FIG. 4 is a section along IV-IV of FIG. 1.

FIG. 5 is a partial section along V-V of FIG. 1.

FIG. 6 is a back view showing the connector in which a retainer is temporarily held.

FIG. 7 is a side view showing an interfering state of a cover and the retainer.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure is for holding a first terminal and a second terminal and provided with a housing including a first terminal accommodating portion having a first cavity for accommodating the first terminal and a second terminal accommodating portion having a second cavity for accommodating the second terminal, a first holding member for holding the first terminal in the first cavity by being united with the first terminal accommodating portion at a first proper position, and a second holding member for holding the second terminal in the second cavity by being united with the second terminal accommodating portion at a second proper position, the first holding member reaching the first proper position along a first direction to be united with the first terminal accommodating portion, and the second holding member reaching the second proper position along a second direction different from the first direction to be united with the second terminal accommodating portion.

According to the present disclosure, the first direction when the first holding member reaches the first proper position and the second direction when the second holding member reaches the second proper position are different. Thus, an operation of setting the first terminal and uniting the first holding member and an operation of setting the second terminal and uniting the second holding member can be clearly distinguished and performed. Thus, it is suppressed that the terminals are set in wrong cavities and an assembly failure of the connector is suppressed.

(2) In the connector of (1), the second holding member moving to the second proper position along the second direction may be set to have such a positional relationship as to interfere with the first holding member located before the first proper position.

In this case, the second holding member interferes with the first holding member with the first holding member located before the first proper position. Thus, it can be known that the first holding member is not assembled at a proper position if the second holding member cannot be moved to the second proper position. In this way, an assembly failure of the connector is suppressed.

(3) In the connector of (1) or (2), the first terminal accommodating portion may include a first setting opening on a side opposite to the second terminal accommodating portion, the first direction may be a direction along an extension direction of the first cavity, the first proper position may be a position where the first holding member closes the first setting opening, the second terminal accommodating portion may include a second setting opening on one side in an extension direction of the second cavity and a positioning opening on a side opposite to the first terminal accommodating portion, the second direction may be a direction intersecting the extension direction of the second cavity, and the second proper position may be a position where the second holding member is fit in the positioning opening.

In this case, the first holding member can reach the first proper position along the first direction along the extension direction of the first cavity. The second holding member can reach the second proper position along the second direction intersecting the extension direction of the second cavity. Thus, a setting operation of the first terminal and that of the second terminal can be made clearly different and an assembly failure of the connector is suppressed.

(4) In the connector of (3), a first terminal positioning protrusion may be formed on a side opposite to the first setting opening, out of an inner peripheral side of the first cavity, and the second holding member may be formed with a second terminal positioning protrusion projectable into the second cavity.

In this way, the first terminal in the first cavity can be positioned by the first terminal positioning protrusion from the side of the second terminal accommodating portion. The second terminal in the second cavity can be positioned by the second terminal positioning protrusion projecting into the second cavity from the side of the positioning opening. Thus, the postures of the terminals are easily aligned in the first and second cavities. Further, since the first holding member needs not be formed with a terminal positioning protrusion, a configuration in which the first holding member moves along the extension direction of the first cavity and reaches the first proper position is easily realized.

(5) In the connector of (4), the second terminal positioning protrusion may interfere with the second terminal with the second terminal improperly set in the second cavity, and at least a part of the second holding member may project from the housing with the second terminal positioning protrusion interfering with the second terminal and with the second holding member moving to the second proper position along the second direction interfering with the first holding member located before the first proper position.

In this case, if at least a part of the second holding member projects from the housing, it can be known that the first holding member has not reached the first proper position or the second terminal is improperly set in the second cavity.

(6) In the connector of any one of (3) to (5), the first holding member may include a cover body for closing the first setting opening and a pair of side wall portions extending from both sides of the cover body along both side surfaces of the first terminal accommodating portion, a tip part of at least one of the pair of side wall portions may include a partially projecting interfering protrusion, the interfering protrusion may be arranged at a position to interfere with the second holding member moving toward the second proper position in a state before the first holding member reaches the first proper position, and the interfering protrusion may be arranged at a position retracted from a moving path of the second holding member toward the second proper position with the first holding member located at the first proper position.

In this case, if the first holding member is in an improperly assembled state, the second holding member interferes with the interfering protrusion, whereby the improperly assembled state can be known.

(7) In the connector of (6), the second holding member may include a retainer body to be attached into the positioning opening and a pair of locking wall portions extending from both sides of the retainer body along both sides of the second terminal accommodating portion, and at least one of the pair of locking wall portions may be arranged at a position capable of interfering with the interfering protrusion.

In this way, interference can be realized, utilizing the locking wall portion of the retainer. Since the locking wall portion can be locked to the housing in a part where the interfering protrusion is absent, the locking wall portion can be made longer.

(8) In the connector of (7), the housing may include a pair of locking portions to be locked to the pair of locking wall portions with the second holding member located at the second proper position and a pair of temporary locking portions to be locked to the pair of locking wall portions in a state before the second holding member positions the second terminal, and the first holding member may be set to be movable toward the first proper position while avoiding interference of at least one of the pair of locking wall portions and the interfering protrusion with the pair of locking wall portions locked to the pair of temporary locking portions.

In this way, the first holding member can be moved toward the first proper position with the second holding member temporarily assembled with the housing. Thus, the assembly workability of the connector is excellent.

(9) In the connector of (7) or (8), at least one of the pair of locking wall portions may include a guide protrusion projecting toward the housing and extending along the second direction, the housing may be formed with a guiding groove for guiding the guide protrusion, and a part formed with the guide protrusion, out of the pair of locking wall portions, may be formed to be able to interfere with the interfering protrusion.

In this case, since the part formed with the guide protrusion, out of the pair of locking wall portions, is formed to be able to interfere with the interfering protrusion, an interfering state is more reliably maintained when the first holding member is not assembled at the first proper position.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

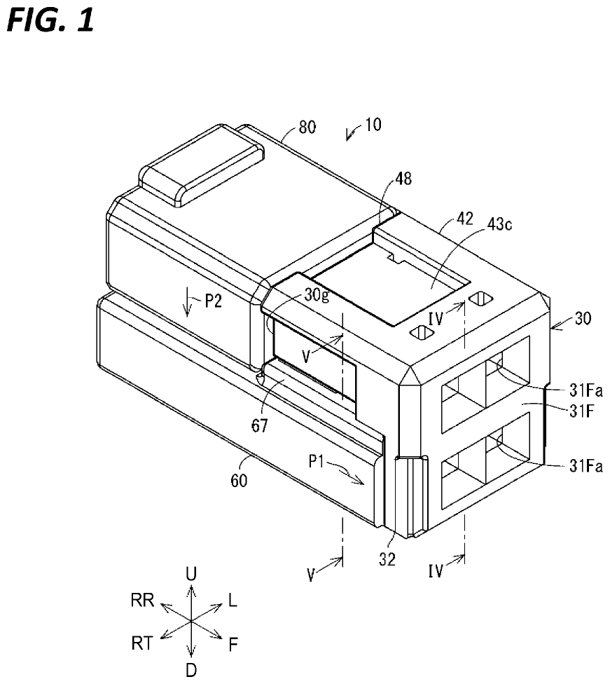

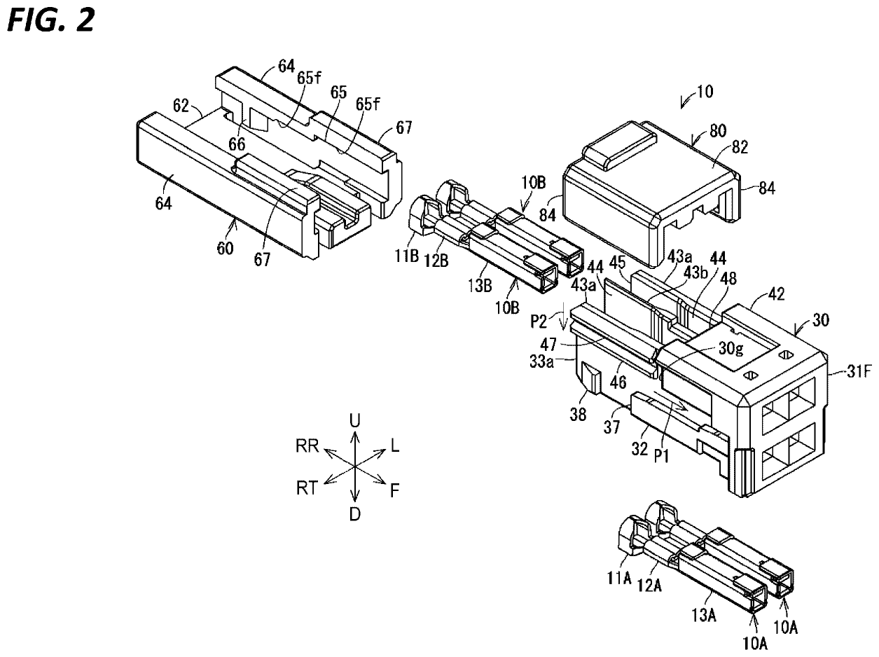

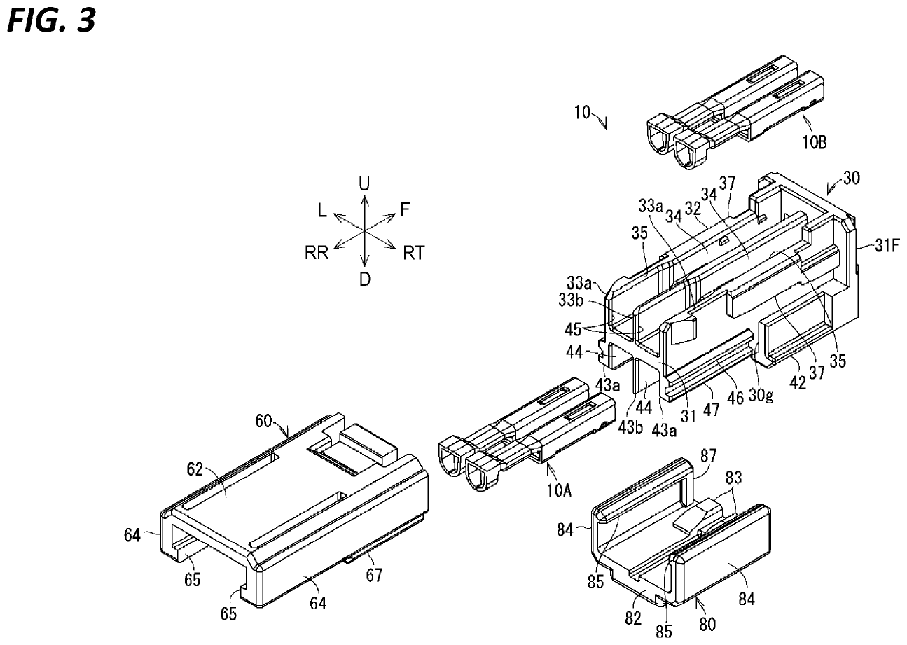

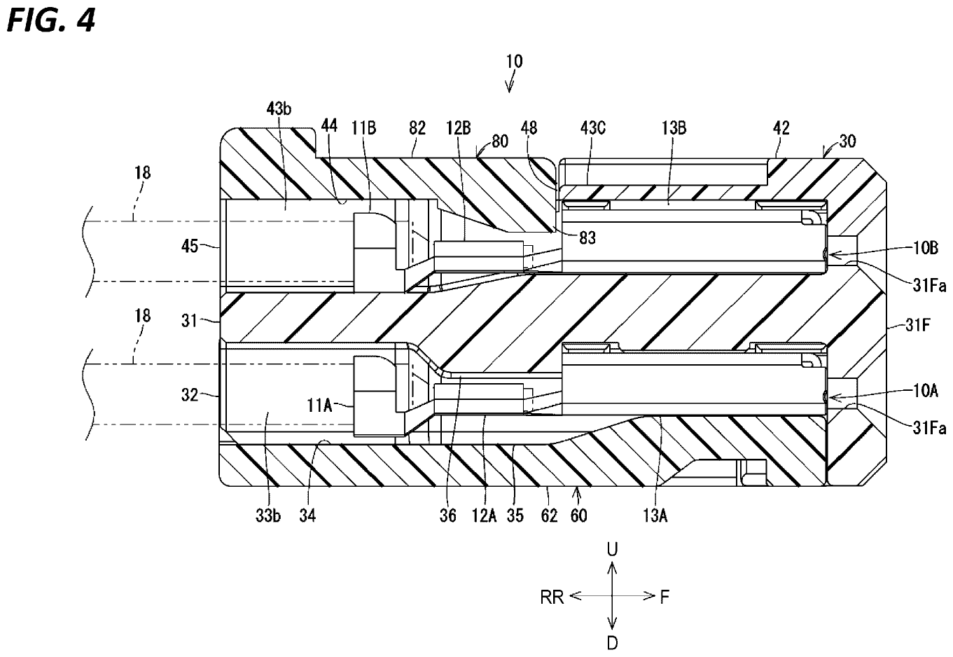

Hereinafter, a connector according to an embodiment is described. FIG. 1 is a perspective view showing a connector 10. FIGS. 2 and 3 are exploded perspective views showing the connector 10. FIG. 4 is a section along IV-IV of FIG. 1. Terminals 10A, 10B are shown in FIGS. 2 to 4, and wires 18 are shown by two-dot chain lines in FIG. 4.

### Overall Structure of Connector

The overall structure of the connector is described. The connector 10 holds first and second terminals 10A, 10B.

The first and second terminals 10A, 10B are formed, such as by press-working a metal plate. The first terminal 10A is provided with a coating crimping portion 11A, a core wire crimping portion 12A and a terminal connecting portion 13A. The coating crimping portion 11A is a part to be crimped to a coating in an end part of the wire 18. The core wire crimping portion 12A is a part to be crimped to a core wire exposed in the end part of the wire 18. The terminal connecting portion 13A is a part to be connected to a mating terminal and, for example, formed into a tubular shape. The coating crimping portion 11A, the core wire crimping portion 12A and the terminal connecting portion 13A are linearly arranged in this order. The coating crimping portion 11A and the terminal connecting portion 13A are thicker than the core wire crimping portion 12A. Thus, when the first terminal 10A is observed from a lateral side, a recess is observed between the coating crimping portion 11A and the terminal connecting portion 13A above the core wire crimping portion 12A.

The second terminal 10B is also provided with a coating crimping portion 11B, a core wire crimping portion 12B and a terminal connecting portion 13B, similarly to the first 10A.

Note that the first and second terminals 10A, 10B may be terminals of the same size, material and the like or may be terminals of different sizes, materials and the like.

In this embodiment, the connector 10 is provided with a plurality of (here, two) the first terminals 10A and a plurality of (here, two) the second terminals 10B. The plurality of first terminals 10A are arranged in parallel in a row. The plurality of second terminals 10B are also arranged in parallel in a row. The plurality of first terminals 10A and the plurality of second terminals 10B are adjacent to each other. That is, the plurality of first terminals 10A and the plurality of second terminals 10B are held separately in a first stage and a second stage in the connector 10. Note that the numbers of the first terminals 10A and the second terminals 10B to be held by the connector 10 are arbitrary.

In the following description, the side of the terminal connecting portion 13 A and the side of the coating crimping portion 11A may be referred to as a front side and a rear side in an extension direction of the first terminal 10A. Further, the side of the first terminals 10A and the side of the second terminals 10B may be referred to as an upper side and a lower side. Furthermore, a lateral direction may be referred to, assuming a state standing on the first terminals 10A and facing forward.

The connector 10 is provided with a housing 30, a cover 60 serving as a first holding member and a retainer 80 serving as a second holding member.

The housing 30 is made of resin or the like and provided with a first terminal accommodating portion 32 and a second terminal accommodating portion 42. The first terminal accommodating portion 32 includes first cavities 34 for accommodating the first terminals 10A. In this embodiment, the first terminal accommodating portion 32 includes a plurality of (here, two) first cavities 34 arranged in parallel. The second terminal accommodating portion 42 includes second cavities 44 for accommodating the second terminals 10B. In this embodiment, the second terminal accommodating portion 42 includes a plurality of (here, two) second cavities 44 arranged in parallel.

The cover 60 is united with the first terminal accommodating portion 32 and holds the first terminals 10A in the first cavities 34. That is, the first terminals 10A are set in the first cavities 34 in a state where the cover 60 is not attached at a first proper position. In this state, the cover 60 is attached to be united with the first terminal accommodating portion 32. Then, the first terminals 10A are prevented from coming out from the first cavities 34. A position where the cover 60 is united with the first terminal accommodating portion 32 to prevent the first terminals 10A from coming out from the first cavities 34 is the first proper position (see FIGS. 1 and 4). A state before the cover 60 reaches the first proper position may be referred to as an improper state.

The retainer 80 is united with the second terminal accommodating portion 42 and holds the second terminals 10B in the second cavities 44. That is, the second terminals 10B are set in the second cavities 44 in a state where the retainer 80 is not attached at a second proper position. In this state, the retainer 80 is attached to be united with the second terminal accommodating portion 42. Then, the second terminals 10B are prevented from coming out from the second cavities 44. A position where the retainer 80 is united with the second terminal accommodating portion 42 to prevent the second terminals 10B from coming out from the second cavities 44 is the second proper position (see FIGS. 1 and 4). A state before the retainer 80 reaches the second proper position may be referred to as an improper state.

The cover 60 can reach the first proper position along a first direction P1 (see FIG. 2) to be united with the first terminal accommodating portion 32. The retainer 80 can reach the second proper position along a second direction P2 (see FIG. 2) different from the first direction to be united with the second terminal accommodating portion 42. Thus, attaching operations of the cover 60 and the retainer 80 to the housing 30 are different. Therefore, an operation of setting and holding the first terminals 10A in the first cavities 34 and an operation of setting and holding the second terminals 10B in the second cavities 44 can be recognized as clearly different operations by a worker.

Further, the retainer 80 moving to the second proper position along the second direction P2 is set to have such a positional relationship as to interfere with the cover 60 if the cover 60 is located before the first proper position. The positional relationship in which the retainer 80 interferes with the cover 60 is a positional relationship in which the retainer 80 contacts the cover 60 and cannot move toward the second proper position. That is, if the cover 60 is incompletely united with the housing 30, the retainer 80 is not completely united with the housing 30. Thus, an incompletely united state of the cover 60 with the housing 30 can be easily detected if the retainer 80 is not completely united with the housing 30, i.e. the retainer 80 cannot reach the second proper position.

The configuration of each component is more specifically described.

### Concerning Holding Structure of First Terminals

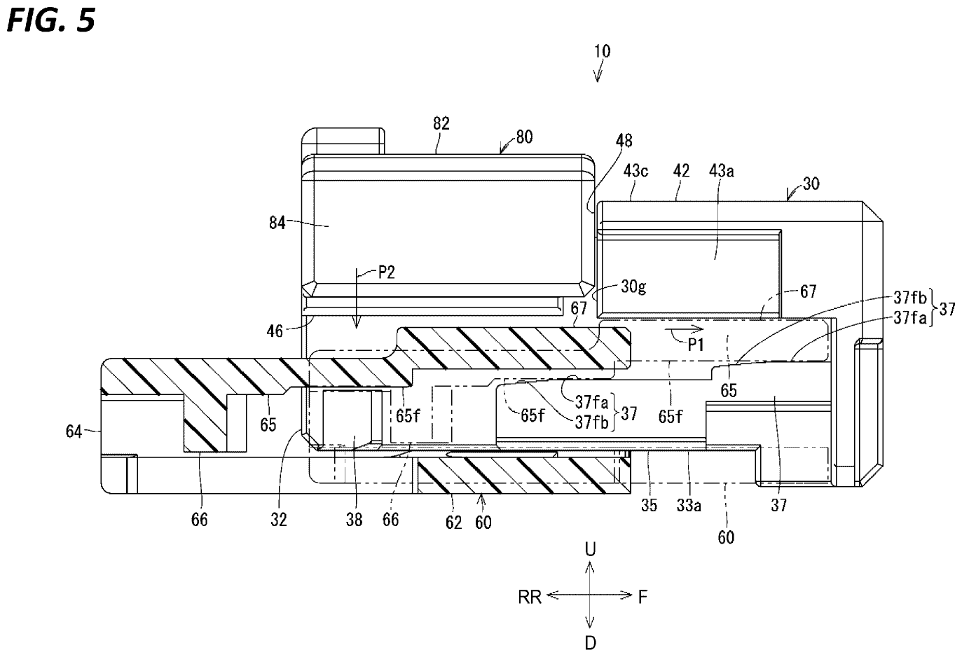

A configuration for holding the first terminals 10A by the first terminal accommodating portion 32 is more specifically described. FIG. 5 is a partial section along V-V of FIG. 1.

As shown in FIGS. 1 to 5, the housing 30 includes a common plate portion 31 located between the first and second terminal accommodating portions 32, 42. A pair of first cavity-side wall 33a extend from both side edges of the common plate portion 31. A middle partition 33b extends from a widthwise middle part of the common plate portion 31. The pair of first cavity-side walls 33a and the middle partition 33b project on the same principal surface side with respect to the common plate portion 31. The pair of first cavity-side walls 33a and the middle partition 33b are arranged in parallel at intervals in a width direction of the housing 30. The first terminal accommodating portion 32 is configured to include a lower part of the common plate portion 31, the pair of first cavity-side walls 33a and the middle partition 33b, and the plurality of first cavities 34 are formed in gaps between the pair of first cavity-side walls 33a and the middle partition 33b.

A front plate portion 31F extending in a direction orthogonal to a front-rear direction is provided on the front edge of the housing 30. The front plate portion 31F is located on the front ends of the first cavities 34. The first terminals 10A arranged in the first cavities 34 are restricted from moving forward by contacting the front plate portion 31F. The front plate portion 31F is formed with connection holes 31Fa, through which mating terminals (e.g. male terminals including elongated plate portions or pin-shaped parts) are insertable. The mating terminal can be connected to the first terminal 10A in the first cavity 34 through this connection hole 31Fa.

The first terminal accommodating portion 32 includes first setting openings 35 on a side opposite to the second terminal accommodating portion 42. The first setting opening 35 is in the form of a slit open downward. The first setting opening 35 is longer than the first terminal 10A. Thus, the first terminal 10A can be set in the first cavity 34 through the first setting opening 35. Specifically, the first terminal 10A can be set into the first cavity 34 through the first setting opening 35 from below the first terminal accommodating portion 32. Note that it is also assumed that the first terminal 10A is set into the first cavity 34 through the first setting opening 35 from above with the first setting opening 35 facing upward during an actual operation. The wire 18 extending from the first terminal 10A can extend out through a rear opening of the first cavity 34.

A first terminal positioning protrusion 36 is formed on a side opposite to the first setting opening 35, out of an inner peripheral part of the first cavity 34. Out of the inner peripheral part of the first cavity 34, a part on the side opposite to the first setting opening 35 is a part on the side of the common plate portion 31. The first terminal positioning protrusion 36 is formed in an intermediate part in an extension direction of the first cavity 34, more specifically in a region where the core wire crimping portion 12A is to be located in the extension direction of the first cavity 34. With the first terminal 10A arranged in the first cavity 34, the first terminal positioning protrusion 36 can be fit into the recess between the coating crimping portion 11A and the terminal connecting portion 13A of the first terminal 10A. In this way, the first terminal 10A is positioned in the extension direction thereof and suppressed from coming out rearward.

The cover 60 is united with the first terminal accommodating portion 32 to close the first setting openings 35. In this way, the first terminals 10A are suppressed from coming out from the first cavities 34. Here, the cover 60 functions to restrict movements of the first terminals 10A in a direction separating from the first terminal positioning protrusions 36 while closing the first setting openings 35. In this way, a state where the first terminal positioning protrusions 36 are fit in the recesses of the first terminals 10A is maintained and the first terminals 10A are suppressed from coming out from the first cavities 34.

As described above, a position where the cover 60 closes the first setting openings 35 is the first proper position (see FIGS. 1 and 4) where the cover 60 is properly united with the first terminal accommodating portion 32. The cover 60 can reach the first proper position by moving along the first direction P1. In this embodiment, the first direction P1 is a direction along the extension direction of the first cavities 34. A configuration example for realizing this configuration is described below.

Specifically, uniting protrusions 37 are formed on the outer surfaces of the pair of first cavity-side walls 33a. Uniting surfaces 37f are formed on the uniting protrusion 37 on the side of the second terminal accommodating portion 42. The uniting surface 37f includes a uniting/supporting surface 37fa along the extension direction of the first terminal 10A and the width direction of the housing 30 and a uniting/guiding surface 37fb inclined toward the second terminal accommodating portion 42 toward a front side. A gap, in which an insertion-side uniting protrusion 65 of the cover 60 can be arranged, is formed on a side closer to the second terminal accommodating portion 42 than the uniting surfaces 37f.

Further, retaining protrusions 38 are formed on the outer surfaces of the pair of first cavity-side walls 33a, here at positions near rear parts. The retaining protrusion 38 is formed into a shape including a part having a projecting dimension gradually reduced toward a rear side.

The cover 60 includes a cover body 62 and a pair of side wall portions 64.

The cover body 62 is in the form of a plate, here a rectangular plate, spreading to be able to collectively close the first setting openings 35 of the plurality of first cavities 34.

The pair of side wall portions 64 are in the form of plates, here elongated plates, extending from both sides of the cover body 62 toward both side surfaces of the first terminal accommodating portion 32. The insertion-side uniting protrusion 65 is formed on the inner surface of the side wall portion 64. The insertion-side uniting protrusion 65 is formed at a position separated from the cover body 62 on the inner surface of the side wall portion 64. Here, the insertion-side uniting protrusion 65 is an elongated protrusion extending along a tip edge on the inner surface of the side wall portion 64. An insertion-side uniting surface 65f is formed on the insertion-side uniting protrusion 65 on the insertion-side uniting protrusion 65 on the side of the cover body 62. The insertion-side uniting surface 65f is a surface along the extension direction of the first terminal 10A and the width direction of the housing 30, similarly to the uniting/supporting surface 37fa.

Further, retaining protrusions 66 are formed on the inner surfaces of the pair of side wall portions 64, here at positions near rear parts. The retaining protrusion 66 is formed into a shape including a part having a projecting dimension gradually reduced toward the front side.

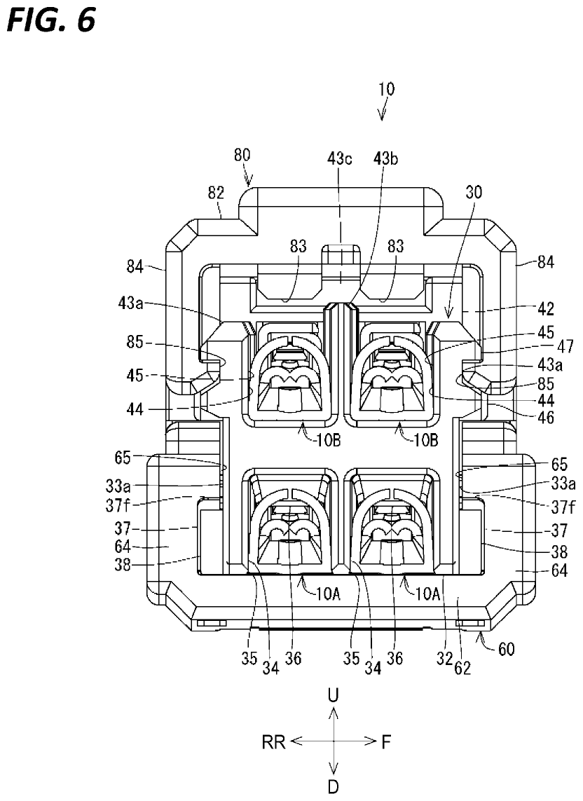

A uniting operation example of the cover 60 is described. With the first terminals 10A accommodated in the first cavities 34, the cover 60 is externally fit to the first terminal accommodating portion 32 from behind the first terminal accommodating portion 32 (see FIG. 6). At this time, the pair of side wall portions 64 are arranged outside the pair of first cavity-side walls 33a and the insertion-side uniting protrusions 65 are inserted into the gaps closer to the second terminal accommodating portion 42 than the uniting protrusions 37.

If the cover 60 is pushed forward, the retaining protrusions 66 ride over the retaining protrusions 38 and are locked to the retaining protrusions 38 so as not to come out rearward. In this state, the cover 60 is in contact with the front plate portion 31F. In this state, the uniting/supporting surfaces 37fa and the insertion-side uniting surfaces 65f are in contact while facing each other, and the cover 60 is suppressed from being detached downward (see two-dot chain line of FIG. 6).

When the cover 60 moves forward, the uniting/guiding surfaces 37f may gradually guide the cover 60 toward the second terminal accommodating portion 42. In this way, in an initial stage, the cover 60 hardly contacts the first terminals 10A and can smoothly move.

The cover 60 only has to move along the first direction P1 when reaching the first proper position and may move in a direction different from the first direction P1 before that. For example, the cover 60 may not be externally fit to the first terminal accommodating portion 32 from behind the first terminal accommodating portion 32. For example, the cover 60 may be pushed toward the first terminal accommodating portion 32 from below the first terminal accommodating portion 32 and the pair of side wall portions 64 may ride over the uniting protrusions 37 from outside in the width direction and enter the gaps closer to the second terminal accommodating portion 42 than the uniting protrusions 37.

As described above, the inner surface of the cover body 62 contacts the first terminals 10A in the first cavities 34 from the side of the first setting openings 35 by uniting the cover 60 with the first terminal accommodating portion 32. In this way, the first terminals 10A are suppressed from moving toward the first setting openings 35 and the first terminal positioning protrusions 36 are kept locked to the first terminals 10A. By locking the first terminal positioning protrusions 36 to the first terminals 10A, the first terminals 10A are suppressed from coming out rearward from the first cavities 34.

### Concerning Holding Structure of Second Terminals

A configuration for holding the second terminals 10B by the second terminal accommodating portion 42 is more specifically described.

In the housing 30, a pair of second cover-side wall 43a extend from the both side edges of the common plate portion 31. A middle partition 43b extends from the widthwise middle part of the common plate portion 31. The pair of second cavity-side walls 43a and the middle partition 43b project on a principal surface side opposite to the pair of first cavity-side walls 33a and the middle partition 33b with respect to the common plate portion 31. The pair of second cavity-side walls 43a and the middle partition 43b are arranged in parallel at intervals in the width direction of the housing 40. Openings defined by the pair of second cavity-side walls 43a and the middle partition 43b on a side opposite to the common plate portion 31 are at least partially closed by a ceiling plate portion 43c. The second terminal accommodating portion 42 is configured to include an upper part of the common plate portion 31, the pair of second cavity-side walls 43a, the middle partition 43b and the ceiling plate portion 43c, and the plurality of second cavities 44 are formed in gaps between the pair of second cavity-side walls 43a and the middle partition 43b.

The front plate portion 31F is also provided at the front ends of the second cavities 44. The second terminals 10B arranged in the second cavities 44 are restricted from moving forward by contacting the front plate portion 31F. The front plate portion 31F is formed with connection holes 31Fa also at positions corresponding to the second cavities 44. The mating terminal can be connected to the second terminal 10B in the second cavity 44 through this connection hole 31Fa.

The second terminal accommodating portion 42 includes second setting openings 45 on one side in an extension direction of the second cavities 44, here on a rear side. The second setting opening 45 is larger than a shape obtained by projecting the second terminal 10B in the front-rear direction. Thus, the second terminal 10B can be set in the second cavity 44 through the second setting opening 45. Note that the first terminal positioning protrusion 36 projecting into the first cavity 34 is formed in the first cavity 34. Thus, if the first terminal 10A is inserted through the rear opening of the first cavity 34, the first terminal 10A is thought to be caught by the first terminal positioning protrusion 36 on the way. Thus, it is thought to be proper to set the first terminal 10A through the first setting opening 35 for the first cavity 34. Since a protrusion for retention similar to the first terminal positioning protrusion 36 is not provided in the second cavity 44, the second terminal 10B is smoothly set into the second cavity 44 through the second setting opening 45.

The second terminal accommodating portion 42 includes positioning openings 48 on a side opposite to the first terminal accommodating portion 32. The positioning openings 48 are openings, into which the retainer 80 for positioning is attached. In this embodiment, the positioning openings 48 are formed on sides of the second cavities 44 opposite to the first terminal accommodating portion 32. The positioning openings 48 are located behind the ceiling plate portion 43c. In this embodiment, the positioning opening 48 reaches a rear opening of the second cavity 44, i.e. the second setting opening 45. It is also assumed that a positioning opening is partially formed in an intermediate part in an extension direction of a second cavity.

The recess between the coating crimping portion 11B and the terminal connecting portion 13B of the second terminal 10B set in the second cavity 44 is arranged at a position exposed to outside via the second setting opening 45.

The retainer 80 is united with the second terminal accommodating portion 42 to be fit into the positioning openings 48. In this state, the retainer 80 is fit into the recesses of the second terminals 10B and the second terminals 10B are suppressed from coming out toward the second setting openings 45 from the second cavities 44.

As described above, a state where the retainer 80 is fit in the positioning openings 48 and the recesses of the second terminals 10B is reached at the second proper position (see FIGS. 1 and 4). The retainer 80 can reach the second proper position by moving along the second direction P2. In this embodiment, the second direction P2 is a direction intersecting the extension direction of the second cavities 44, more specifically a direction orthogonal to the extension direction of the second cavities 44. A configuration example for realizing this configuration is described below.

Specifically, a pair of locking portions 46 and a pair of temporary locking portions 47 are formed on the outer surfaces of the pair of second cavity-side walls 43a.

The pair of locking portions 46 project outward from the outer surfaces of the pair of second cavity-side walls 43a. The pair of locking portions 46 are formed into a shape including a part having a projecting dimension gradually reduced toward the tips of the second cavity-side walls 43a, i.e. toward an upper side.

The pair of temporary locking portions 47 project outward from the outer surfaces of the pair of second cavity-side walls 43a. The pair of temporary locking portions 47 are formed into a shape including a part having a projecting dimension gradually reduced toward to the tips of the second cavity-side walls 43a, i.e. toward the upper side.

The pair of temporary locking portions 47 are located on a side more distant from the first terminal accommodating portion 32 than the pair of locking portions 46, i.e. on the upper side. Thus, the retainer 80 can be locked to the pair of locking portions 46 after being temporarily locked by the pair of temporary locking portions 47.

The retainer 80 includes a retainer body 82 and the pair of locking wall portions 84.

The retainer body 82 is in the form of a plate, here a rectangular plate, spreading to be able to collectively close the positioning openings 48 corresponding to the plurality of second cavities 44.

The retainer body 82 is formed with second terminal positioning protrusions 83. Here, a plurality of the second terminal positioning protrusions 83 are formed in parallel to correspond to the plurality of cavities 44. The second terminal positioning protrusion 83 is formed in an intermediate part in the extension direction of the second cavity 44, more specifically in a region in the extension direction of the cavity 44 where the core wire crimping portion 12B is to be located. With the retainer body 82 attached in the positioning openings 48, the second terminal positioning protrusions 83 can project into the second cavities 44. In this state, the second terminal positioning protrusion 83 can be fit into the recess between the coating crimping portion 11B and the terminal connecting portion 13B of the second terminal 10B in the second cavity 44. In this way, the second terminal 10B is positioned in an extension direction thereof and suppressed from coming out rearward.

The pair of locking wall portions 84 extend from both sides of the retainer body 82 along both sides of the second terminal accommodating portion 42, here along the outer surfaces of the pair of second cavity-side walls 43a. Retaining protrusions 85 are formed at positions near tips on the inner surfaces of the pair of locking wall portions 84. The retaining protrusion 85 is a protrusion projecting from the inner surface of the locking wall portion 84. The retaining protrusion 85 is formed into a shape including a part having a projecting dimension gradually reduced toward a tip side of the locking wall portion 84. The pair of locking wall portions 84 can be locked to the pair of temporary locking portions 47 or the pair of locking portions 46.

At least one of the pair of locking wall portions 84 includes a guide protrusion 87 projecting toward the housing 30 and extending along the second direction P2 (here, vertical direction). In this embodiment, the guide protrusion 87 is formed along the front edge of the inner surface of the locking wall portion 84.

The housing 30 is formed with guiding grooves 30g for guiding the guide protrusions 87. The guiding groove 30g is formed between the front ends of the locking portion 46 and the temporary locking portion 47 and a protrusion separated forward from these front ends.

When the retainer 80 is attached to the second terminal accommodating portion 42 along the second direction P2, the guide protrusions 87 are guided along the guiding grooves 30g. In this way, the retainer 80 can smoothly move along the second direction P2. Further, with the retainer 80 properly united with the second terminal accommodating portion 42 and located at the second proper position, the guide protrusions 87 are in contact with side surfaces of the guiding grooves 30g, here the front ends of the locking portions 46 and the temporary locking portions 47. In this way, the retainer 80 is suppressed from being detached rearward from the second terminal accommodating portion 42.

In this embodiment, a protrusion is formed at a rather forward position of an intermediate part of the inner surface of the retainer body 82, and the retainer 80 is suppressed from being detached rearward also by this protrusion being fit into a recess formed in the middle partition 43b.

A uniting operation example of the retainer 80 is described.

For example, an assembly in which the pair of retaining protrusions 85 of the retainer 80 are locked to the pair of temporary locking portions 47 is prepared (see FIG. 6). In this state, the second terminal positioning protrusions 83 do not project into the second cavities 44. Thus, the second terminal 10B can be smoothly inserted into the second cavity 44 through the second setting opening 45 on the rear side. That is, the pair of temporary locking portions 47 are locked to the retaining protrusions 85 of the pair of locking wall portions 84 in a state before the retainer 80 positions the second terminals 10B.

With the second terminals 10B accommodated in the second cavities 44, the retainer 80 is further pushed. When being pushed in, the retainer 80 can smoothly move along the second direction P2 since the guide protrusions 87 are guided by the guiding grooves 30g. If the retainer 80 is pushed, the pair of retaining protrusions 85 ride over the pair of locking portions 46 and are retained and locked to this pair of locking portions 46. In this way, the retainer 80 moves along the second direction P2, reaches the second proper position and is properly united with the second terminal accommodating portion 42. That is, with the retainer 80 located at the second proper position, the pair of locking portions 46 are locked to the retaining protrusions 85 of the pair of locking wall portions 84.

The retainer 80 only has to move along the second direction P2 when reaching the second proper position, and may move in a direction different from the second direction P2 before that. Further, the second direction P2 may be a direction different from a direction orthogonal to the extension direction of the second cavities 44, e.g. a direction oblique to the extension direction of the second cavities 44.

### Concerning Configuration for Interference

As described above, the retainer 80 moving to the second proper position along the second direction P2 is set to have such a positional relationship as to interfere with the cover 60 if the cover 60 is located before the first proper position. A configuration example for that is described.

A tip part of at least one of the pair of side wall portions 64 of the cover 60 includes an interfering protrusion 67. In this embodiment, each of the both side wall portions 64 includes the interfering protrusion 67. The interfering protrusion 67 projects toward the second terminal accommodating portion 42 from the tip of the side wall portion 64. The interfering protrusion 67 partially projects in the front-rear direction on the tip of the side wall portion 64. Thus, a part of the side wall portion 64 where the interfering protrusion 67 is not formed is partially recessed from the interfering protrusion 67.

The interfering protrusion 67 is formed at a position to interfere with the locking wall portion 84 of the retainer 80 moving toward the second proper position in a state before the cover 60 reaches the first proper position. Further, the interfering protrusion 67 is formed at a position retracted from a moving path of the locking wall portion 84 of the retainer 80 moving toward the second proper position with the cover 60 located at the first proper position.

In this embodiment, the side wall portions 64 of the cover 60 and the locking wall portions 84 of the retainer 80 are vertically facing each other on the side surfaces of the housing 30. In the front-rear direction, the locking wall portion 84 of the retainer 80 partially overlaps the side wall portion 64 of the cover 60. The interfering protrusion 67 is not formed in a part of the side wall portion 64 of the cover 60 overlapping the locking wall portion 84 in the front-rear direction. The interfering protrusion 67 is formed before the part of the side wall portion 64 of the cover 60 overlapping the locking wall portion 84 in the front-rear direction.

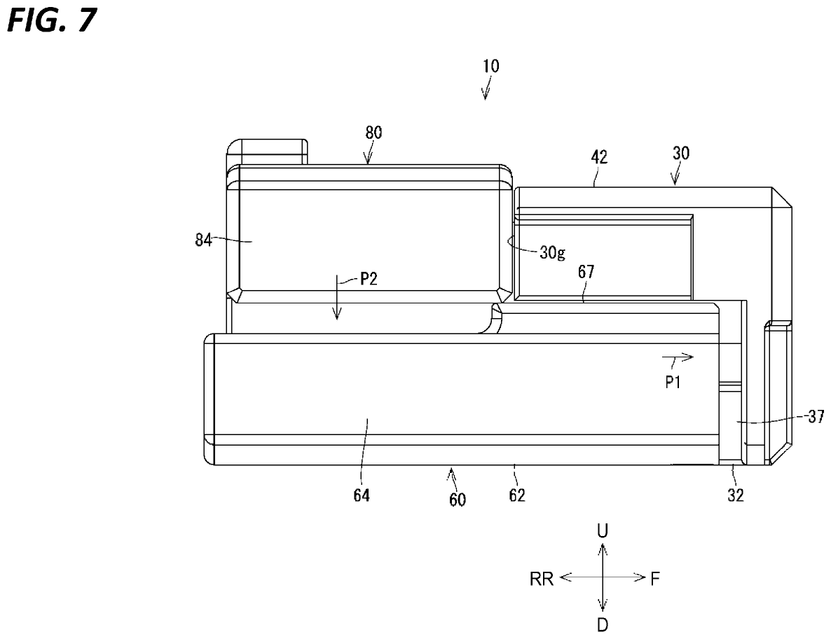

For example, it is assumed that the cover 60 is located before the first proper position along the first direction P1 (see FIG. 7). In this state, rear end parts of the interfering protrusions 67 are located below front end parts of the locking wall portions 84. Thus, if the retainer 80 is pushed in the above state, the locking wall portions 84 interfere with the interfering protrusions 67. In this way, the retainer 80 cannot be pushed down and is kept in a state projecting from the upper surface of the housing 30.

Thus, it is possible to easily notice a possibility that the cover 60 is improperly united by noticing that the retainer 80 cannot be properly united at the time of attaching the retainer 80.

Note that since the part formed with the guide protrusion 87, out of the locking wall portion 84, interferes with the interfering protrusion 67, the locking wall portion 84 interfering with the guide protrusion 87 is hardly deformed. Thus, for example, even if the retainer 80 is pushed down with a strong force, the locking wall portions 84 interfering with the interfering protrusions 67 are hardly deformed outward and an interfering state of the locking wall portions 84 and the interfering protrusions 67 is easily kept.

Further, if the second terminal 10B is not sufficiently inserted to the back of the second cavity 44, the second terminal positioning protrusion 83 interferes with the coating crimping portion 11B. Thus, even if the second terminal 10B is improperly set in the second cavity 44, the second terminal positioning protrusion 83 interferes with the second terminal 10B and the retainer 80 cannot be pushed down. Also in this case, it is possible to easily notice a possibility that the second terminal 10B is improperly set by noticing that the retainer 80 cannot be properly united at the time of attaching the retainer 80.

That is, the improperly united cover 60 or the improperly set second terminal 10B can be noticed if the retainer 80 cannot be properly united. That the retainer 80 is not properly united can be easily noticed by confirming that a part of the retainer 80 projects from the upper surface of the housing 30 as described above.

If the cover 60 is properly united and if the second terminals 10B are inserted to the backs, the retaining protrusions 85 of the pair of locking wall portions 84 are locked to the locking portions 46. In this state, the upper surface of the retainer 80 is arranged to be flush with the upper surface of the housing 30 or may be recessed from this upper surface.

Note that, with the retaining protrusions 85 of the locking wall portions 84 of the retainer 80 locked to the temporary locking portions 47, tip parts of the locking wall portions 84 are arranged at positions retracted from moving paths of the interfering protrusions 67. Thus, with the retainer 80 temporarily attached to the second terminal accommodating portion 42, the cover 60 can move along the first direction P1 and reach the first proper position without the interfering protrusion 67 interfering with the locking wall portions 84.

Thus, an assembly in which the retainer 80 is temporarily held on the housing 30 is prepared, and the first terminals 10A, the second terminals 10B, the cover 60 and the like can be assembled with the housing 30 having the retainer 80 temporarily attached thereto.

### Effects, Etc.

According to the connector configured as described above, the cover 60 serving as the first holding member reaches the first proper position along the first direction P1 to be united with the first terminal accommodating portion 32, and the retainer 80 serving as the second holding member reaches the second proper position along the second direction P2 different from the first direction P1 to be united with the second terminal accommodating portion 42. Thus, the first direction P1 in which the retainer 80 moves to be united, and the second direction P2 in which the cover 60 moves to be united are different. Therefore, an operation of setting the first terminals 10A and uniting the cover 60 and an operation of setting the second terminals 10B and uniting the retainer 80 are clearly distinguished and performed. Thus, it is suppressed that the first and second terminals 10A, 10B are mistaken and setting destinations thereof are mistaken, and an assembly failure of the connector 10 is suppressed. Further, since a mistake between the first and second terminals 10A, 10B can be suppressed, assembly workability is improved to contribute to the cost reduction of the connector 10.

Further, the retainer 80 interferes with the cover 60 with the cover 60 located before the first proper position. Thus, it can be known that the cover is not assembled at the first proper position if the retainer 80 cannot be moved to the second proper position. An attachment failure of the cover 60 is more reliably detected, and the occurrence of an assembly failure of the connector 10 is suppressed. Further, since an assembly failure is easily inspected, contribution is made to the cost reduction of the connector 10.

Further, the cover 60 can reach the first proper position along the first direction Pl along the extension direction of the first cavities 34. The retainer 80 can reach the second proper position along the second direction P2 intersecting the extension direction of the second cavities 44. Thus, at the time of a uniting failure of the cover 60, the cover 60 and the retainer 80 are easily caused to interfere. Further, the uniting operations of the cover 60 and the retainer 80 can be made clearly different and an assembly failure of the connector 10 due to a mistake between the terminals 10A and 10B and the like is more suppressed.

Further, the first cavities 34 are formed with the first terminal positioning protrusions 36 and the retainer 80 is formed with the second terminal positioning protrusions 83. Thus, the first terminals 10A in the first cavities 34 can be positioned by the first terminal positioning protrusions 36 from the side of the second terminal accommodating portion 42. The second terminals 10B in the second cavities 44 can be positioned by the second terminal positioning protrusions 83 from the positioning openings 48. Thus, the orientations of the recesses, into which the positioning protrusions 36, 83 are fit, can be aligned in the first and second cavities 34, 44, and the postures of the terminals 10A, 10B are easily aligned. Further, since the retainer 80 needs not be formed with terminal positioning protrusions, a configuration in which the retainer 80 moves along the first direction P1 along the extension direction of the first cavities 34 and reaches the first proper position is easily realized.

Further, if at least a part of the retainer 80 projects from the housing 30, it can be known that the cover 60 has not reached the first proper position or the second terminal 10B is improperly set in the second cavity 44. That is, by observing a state at one position, the occurrence of a failure at either one of two positions can be detected.

Further, the tip part of the side wall portion of the retainer 80 partially projects to form the interfering protrusion 67. In a state before the retainer 80 reaches the first proper position, the interfering protrusions 67 interfere with the retainer 80 moving toward the second proper position. Further, with the retainer 80 located at the first proper position, the interfering protrusions 67 are arranged at the positions retracted from the moving path of the retainer 80 toward the second proper position. Thus, if the cover 60 is improperly assembled, the retainer 80 interferes with the interfering protrusions 67, whereby this improperly assembled state can be known.

Further, since the locking wall portions 84 of the retainer 80 can interfere with the interfering protrusions 67, a configuration for making the improperly assembled state of the cover 60 known can be realized, utilizing the locking wall portions 84 of the retainer 80. Further, since the locking wall portions 84 can be locked to the housing 30 in parts where the interfering protrusions 67 are absent, the locking wall portions 84 can be made longer. In this way, resilient deformation regions of the locking wall portions 84 can be increased, which contributes to a smooth uniting operation of the retainer 80.

Further, with the retainer 80 temporarily locked, the cover 60 can move toward the first proper position while avoiding the interference of the locking wall portions 84 and the interfering protrusions 67. Thus, the connector 10 can be assembled, utilizing not the housing 30 and the retainer 80 as separate components, but a temporary assembly of the both. In this way, the assembly workability of the connector 10 is excellent.

Further, since parts formed with the guide protrusions 87, out of the pair of locking wall portions 84, are formed to be able to interfere with the interfering protrusions 67, the locking wall portions 84 are hardly deformed even if the locking wall portions 84 interfere with the interfering protrusions 67. Thus, the interfering state is more reliably maintained.

Note that the respective configurations described in the above embodiment and the respective modifications can be appropriately combined without contradicting each other.

### List of Reference Numerals

10 connector
10A first terminal
10B second terminal
11A, 11B coating crimping portion
12A, 12B core wire crimping portion
13A, 13B terminal connecting portion
18 wire
30 housing
30g guiding groove
31 common plate portion
31F front plate portion
31Fa connection hole
32 first terminal accommodating portion
33a first cavity-side wall
33b middle partition
34 first cavity
35 first setting opening
36 first terminal positioning protrusion
37 uniting protrusion
37f uniting surface
37fa uniting/supporting surface
37fb uniting/guiding surface
38 retaining protrusion
42 second terminal accommodating portion
43a second cavity-side wall
43b middle partition
43c ceiling plate portion
44 second cavity
45 second setting opening
46 locking portion
47 temporary locking portion
48 positioning opening
60 cover (first holding member)
62 cover body
64 side wall portion
65 insertion-side uniting protrusion
65f insertion-side uniting surface
66 retaining protrusion
67 interfering protrusion
80 retainer (second holding member)
82 retainer body
83 second terminal positioning protrusion
84 locking wall portion
85 retaining protrusion
87 guide protrusion
P1 first direction
P2 second direction

1. A connector for holding a first terminal and a second terminal, comprising:
a housing including a first terminal accommodating portion having a first cavity for accommodating the first terminal and a second terminal accommodating portion having a second cavity for accommodating the second terminal;
a first holding member for holding the first terminal in the first cavity by being united with the first terminal accommodating portion at a first proper position; and
a second holding member for holding the second terminal in the second cavity by being united with the second terminal accommodating portion at a second proper position,
the first holding member reaching the first proper position along a first direction to be united with the first terminal accommodating portion, and
the second holding member reaching the second proper position along a second direction different from the first direction to be united with the second terminal accommodating portion.

212. The connector of claim 1, wherein the second holding member moving to the second proper position along the second direction is set to have such a positional relationship as to interfere with the first holding member located before the first proper position.

313. The connector of claim 1, wherein:
the first terminal accommodating portion includes a first setting opening on a side opposite to the second terminal accommodating portion,
the first direction is a direction along an extension direction of the first cavity,
the first proper position is a position where the first holding member closes the first setting opening,
the second terminal accommodating portion includes a second setting opening on one side in an extension direction of the second cavity and a positioning opening on a side opposite to the first terminal accommodating portion,
the second direction is a direction intersecting the extension direction of the second cavity, and
the second proper position is a position where the second holding member is fit in the positioning opening.

4. The connector of claim 3, wherein:
a first terminal positioning protrusion is formed on a side opposite to the first setting opening, out of an inner peripheral side of the first cavity, and
the second holding member is formed with a second terminal positioning protrusion projectable into the second cavity.

5. The connector of claim 4, wherein:
the second terminal positioning protrusion interferes with the second terminal with the second terminal improperly set in the second cavity, and
at least a part of the second holding member projects from the housing with the second terminal positioning protrusion interfering with the second terminal and with the second holding member moving to the second proper position along the second direction interfering with the first holding member located before the first proper position.

6. The connector of claim 3, wherein:
the first holding member includes a cover body for closing the first setting opening and a pair of side wall portions extending from both sides of the cover body along both side surfaces of the first terminal accommodating portion,
a tip part of at least one of the pair of side wall portions includes a partially projecting interfering protrusion,
the interfering protrusion is arranged at a position to interfere with the second holding member moving toward the second proper position in a state before the first holding member reaches the first proper position, and
the interfering protrusion is arranged at a position retracted from a moving path of the second holding member toward the second proper position with the first holding member located at the first proper position.

7. The connector of claim 6, wherein:
the second holding member includes a retainer body to be attached into the positioning opening and a pair of locking wall portions extending from the both sides of the retainer body along both sides of the second terminal accommodating portion, and
at least one of the pair of locking wall portions is arranged at a position capable of interfering with the interfering protrusion.

8. The connector of claim 7, wherein:
the housing includes a pair of locking portions to be locked to the pair of locking wall portions with the second holding member located at the second proper position and a pair of temporary locking portions to be locked to the pair of locking wall portions in a state before the second holding member positions the second terminal, and
the first holding member is set to be movable toward the first proper position while avoiding interference of at least one of the pair of locking wall portions and the interfering protrusion with the pair of locking wall portions locked to the pair of temporary locking portions.

9. The connector of claim 7, wherein:
at least one of the pair of locking wall portions includes a guide protrusion projecting toward the housing and extending along the second direction,
the housing is formed with a guiding groove for guiding the guide protrusion, and
a part formed with the guide protrusion, out of the pair of locking wall portions, is formed to be able to interfere with the interfering protrusion.
